(19) United States
(12) Patent Application Publication
(10) Pub. No.: US 2003/0233270 A1
(43) Pub. Date: Dec. 18, 2003

(54) Apparatus and method for identifying and contacting potential friends and partners

(76) Inventor: Charles P. Buss, Rancho Santa Margarita, CA (US)

Correspondence Address: Mark F. Wright, Wright Law Group, PLLC, 7201 West Oakland, Suite 2, Chandler, AZ, 85226, US

(21) Appl. No.: 10/174,198

(22) Filed: Jun. 17, 2002

(51) Int. Cl. G06F 17/60

(52) U.S. Cl. 705/10

(57) ABSTRACT

The apparatus and methods of the present invention provide a mechanism for identifying and contacting potential friends and companions by placing a program participant identifier printed with identifying indicia in or on a motor vehicle and then correlating at least one piece of information associated with the program participant identifier to identify a specific program participant. In the most preferred embodiments of the present invention, the license plate of the vehicle displaying the program participant identifier is the medium for identifying the potential friend or partner.

### BACKGROUND OF THE INVENTION

1. Technical Field

The present invention relates generally to matchmaking services and more specifically relates to novel methods for identifying potential friends and partners from chance encounters.

2. Background Art

Traditionally, many personal relationships and marriages were arranged by families or friends and acquaintances. In addition, the intimacy of small town communities provided many chances for couples to meet, get to know each other, and form casual friendships and/or more permanent and romantic relationships. However, as the pace of life has accelerated, and as populations have become more urbanized, people have found that their lifestyles and schedules provide them with fewer opportunities to meet potential partners with whom to form relationships. Consequently, many people have turned to less traditional means of finding potential friends and partners.

For example, people seeking dates have used personal ads as a means to meet others with similar interests. In these ads, the person seeking a match provides information about his or her own personality traits and about the traits he or she desires in others. With the exception of a few items, such as sex, race, and age, however, there is little uniformity in the information included in these ads. Because the persons placing these ads could only predict the types of information that a reader would want in deciding whether to arrange to meet, many of these ads failed to produce successful matches. The lack of uniformity, and the unorganized nature of classified ads, also requires the reader to expend extensive amounts of time sorting through the ads to find a potential match. There is no quick way for the reader to quickly scan through these ads to eliminate those persons who possess unacceptable traits. Moreover, the lack of uniformity in the ads may prevent a reader from obtaining information about a trait that the reader deemed to be essential in a potential friend or partner. In addition to these various problems, most people still like to see what a person looks like prior to investing too much time and/or energy investigating a person who may not be visually attractive to them.

Computer dating services provided a more organized method of classifying users, and of providing a way to quickly screen candidates. Those services, however, still failed to provide adequate compatible matches in many cases. Detailed information about the operation of such dating systems is not generally available, however, it is believed that most computer dating systems fall into two basic types: (1) linear matching; and (2) one-way compatibility screening.

In the first type of dating service, the person seeking a date is asked to answer a questionnaire and characterize himself or herself according to a limited set of criteria. These criteria usually include physical characteristics such as age, weight, race, and marital status, along with psychological characteristics such as extroversion/introversion. After entering this data into the computer, the computer dating service compares this new data to that already contained in the questionnaires filled out by other subscribers to find those that have similar characteristics. This similar/non-similar type of matching fails to take into account the fact that persons may place different emphasis on a trait in others than on a trait that they themselves exhibit. Moreover, this type of matching fails to account for the fact that males and females place significantly different emphasis on the weighting of factors and also have significantly different tolerances for variability in factors.

The second type of traditional dating service solves some but not all of these problems. Such a service asks the user to fill out not just one questionnaire about their own traits, but also another questionnaire indicating the characteristics desired in a potential match. The dating service then uses the criteria specified in the second questionnaire to search through the pool of users and find potential matches. While such a method accounts for the individual desires of the person seeking a match, it fails to account for how desirable the match would find the user. Thus, while the potential match may fit the criteria of the person seeking the match, there is no attempt to determine whether the match will find the other person compatible (i.e., a two-way match). Some of these computer dating services may attempt to bring a more personal touch to the search by providing video footage of prospective friends and partners, but these services are more costly and not all people are willing to shoot the footage for review by other people.

With the advent of the Internet, additional methods and techniques for meeting potential friends and partners have been introduced and some of the problems associated with the previous methods have been addressed. Most of these new methods follow a fairly similar pattern. A person wishing to look for a potential friend or partner will navigate to a web site, sign up for the service, enter information about themselves and their desired friend or partner, and then let the computer software search the database for matches. Once again, while this technique may be successful, it is haphazard and generally forces a person to pay a fee prior to performing any meaningful searches. Yet another problem is that many of these web-based services don't offer any kind of geographic screening capabilities. Accordingly, even if a potential friend or partner is found in the database, they may not be in a geographically convenient location. This can lead to further frustration and futility.

As with other techniques, there may or may not be anyone in the database that matches the desired profile and the money to register for the service may have been spent with no real progress having been made. In addition, although many of these sites offer photos, the quality of the photos is spotty and a picture is still less satisfying than seeing the whole person, in real life. Finally, many people post photos that are older and/or not very representative of the way they look today. Most of these internet matchmaking systems, while an improvement over the more conventional types of services such as newspaper-type personal ads, still don't offer much additional benefit and still don't offer the ability to see what a person really looks like.

As shown by the discussion above, while there are many different ways for people to meet potential friends and partners, all of the methods are somewhat unsatisfying from several different perspectives because they don't let people really focus on some of the most important elements of many relationships, that is, meeting someone and seeing them prior to making an investment in the necessary time and energy to investigate compatibility at a more fundamental level. While looks are not the only criteria for selecting potential friends and partners, most people still seek for and respond to a certain type of person, often times based initially on their looks. However, as described above, conventional services don't provide this type of introduction. Even if pictures are used, pictures don't always tell the whole story about a person's looks.

Another problem that has surfaced is the need for funding the match-making service and the overhead associated with it. While the Internet has proven very popular and has a very wide reach to a large audience, many corporate sponsors have found that it is somewhat difficult to successfully isolate and reach their target audience through conventional internet-based services. Accordingly, most corporate sponsors have been slow to invest much money into web-based ventures for matchmaking type services. This has left the services with few options other than charging fees to the users of the service.

Accordingly, without improved methods for locating, screening, identifying and contacting potential partners, it will be increasingly difficult for single people to find their ideal companions in the hustle and bustle of modern living. Additionally, without the ability to successfully target and reach specific demographic groups within the larger audience of users, it will be difficult to convince corporate sponsors to assist in funding and supporting web-based introduction services and it will be necessary for the users to fund the operations. This will further limit and otherwise hamper the growth and viability of the services.

### DISCLOSURE OF INVENTION

The apparatus and methods of the present invention provide a mechanism for identifying and contacting potential friends and companions by placing a program participant identifier printed with identifying indicia in or on a motor vehicle and then correlating at least one piece of information associated with the program participant identifier to identify a specific program participant. In the most preferred embodiments of the present invention, the license plate of the vehicle displaying the program participant identifier is the medium for identifying the potential friend or partner.

### BRIEF DESCRIPTION OF DRAWINGS

The preferred embodiments of the present invention will hereinafter be described in conjunction with the appended drawings, wherein like designations denote like elements, and:

FIG. 1 is a diagram of a computer suitable for operating a system for introducing potential friends and partners according to a preferred embodiment of the present invention;

FIG. 2 is a diagram showing a placement location for a program participant identifier according to a preferred exemplary embodiment;

FIG. 3 is a diagram showing a placement location for a program participant identifier according to an alternative preferred exemplary embodiment;

FIG. 4 is an enlarged view of the program participant identifier of FIG. 2 showing various indicia according to a preferred exemplary embodiment of the present invention;

FIG. 5 is a flow diagram depicting a method for subscribing to a service for meeting potential friends and partners according to a preferred exemplary embodiment of the present invention; and

FIG. 6 is a flow diagram depicting a method for contacting potential friends and partners according to a preferred exemplary embodiment of the present invention.

### BEST MODE FOR CARRYING OUT THE INVENTION

Detailed Description

The preferred embodiments of the present invention provide a unique way of combining on-line and off-line activities in a comprehensive solution to meeting potential friends and partners. Additionally, the large database of program participants, along with the associated program participant demographic information, will provide a tremendous resource for the consortium of corporate sponsors that will be involved in the program. They will be able to target highly specific segments of the program participant database and tailor messages calculated to provide the most efficient and effective advertising results.

In the most preferred embodiments of the present invention, the program participant identifier is used in conjunction with an Internet website to bring program participants together. Participants dangle a program participant identifier from their automobile rearview mirror or place a program participant identifier sticker on a window of their automobile. If one participant is interested in another, then attention should be sought from that individual, then vehicle license plate number and state should be obtained. Participants can then contact one another via the license number and state via the website. Since the initial introduction is based on geographic proximity, the problem of meeting people in the same geographic vicinity is resolved.

Alternatively, even if one person isn't a program participant, they can still identify a potential friend or partner by the program participant identifier. This may induce individuals to go to the Internet web site and sign up so that they can contact the individual that sparked their interest.

In certain preferred embodiments of the present invention, corporate sponsors may be utilized to provide program participant identifiers to people who wish to sign up for the service. Using the sponsor-provided program participant identifier, an individual may go to the appropriate web site and register their information. During the registration process, the individual will be exposed to various advertising messages provided by the sponsor. Additionally, when an individual attempts to retrieve information about a program participant from the web site, marketing messages may be displayed to advertise the goods/services of the program sponsors. Since a great deal of personally identifiable information may be gathered during the registration of program participants, it will become much easier to target specific target audiences. This will be very attractive to corporate sponsors since they will be able to display specific advertising messages to desired groups of consumers.

It is anticipated that sponsors will provide the program participant identifiers as part of various marketing campaigns and promotional activities. In return for the opportunity to market their products and services to the program participants, revenue will be generated for the operator of the program and the web site. With corporate sponsorship and paid advertising, it is anticipated that the service will be free to the program participants. This will enable the service to more quickly attract additional program participants and reach a state of viability more rapidly.

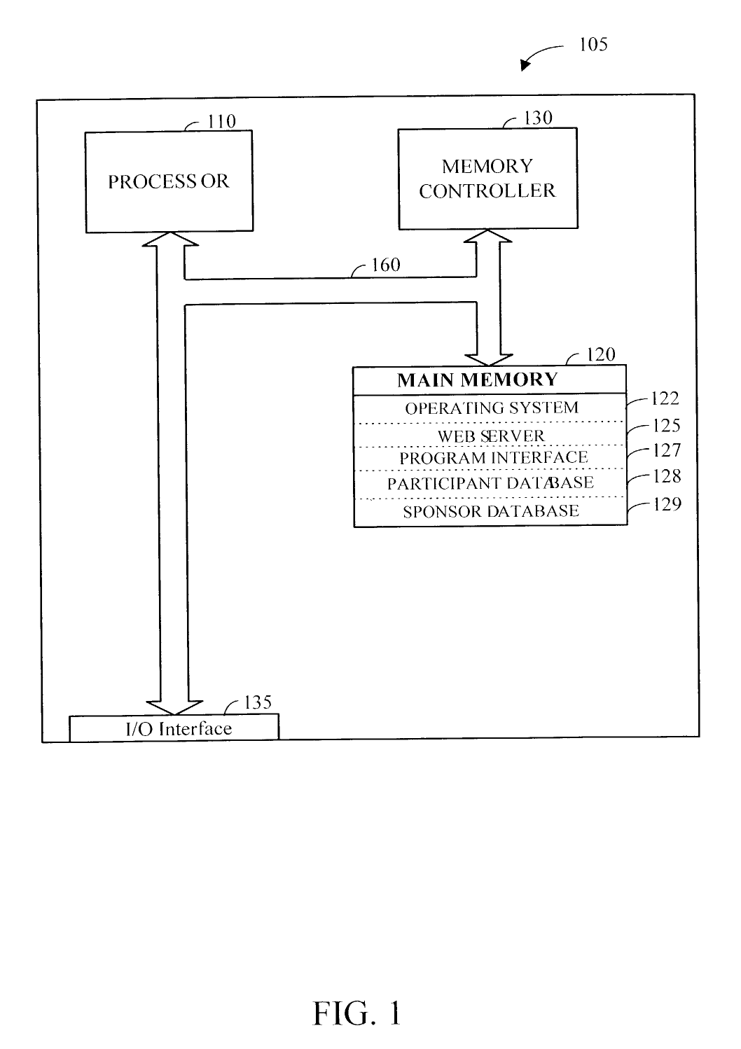

Referring now to FIG. 1, a computer system 105 for operating an introduction service according to a preferred exemplary embodiment of the present invention is shown. As shown in FIG. 1, Computer 105 suitably comprises at least one Central Processing Unit (CPU) or processor 110, a main memory 120, a memory controller 130, and an I/O interface 135, all of which are interconnected via a system bus 160. Note that various modifications, additions, or deletions may be made to computer 105 as illustrated in FIG. 1 within the scope of the present invention such as the addition of cache memory or other peripheral devices. For example, computer 105 may also include a monitor or other display device (not shown) connected to the system bus 160. Alternatively, it is anticipated that computer 105 may be a terminal without a CPU that is connected to a network as a network computer (NC). In that case, the responsibilities and functions of CPU 110 will be assumed and performed by some other device on the network. FIG. 1 is not an exhaustive illustration of any specific computer system or configuration, but is presented to simply illustrate some of the salient features of one preferred embodiment for control system 100.

Processor 110 performs the computation and control functions of computer 105, and may comprise a single integrated circuit, such as a microprocessor, or may comprise any suitable number of integrated circuit devices and/or circuit boards working in cooperation to accomplish the functions of a processor. Processor 110 typically executes and operates under the control of an operating system 122 within main memory 120.

I/O interface 135 allows computer 105 to store and retrieve information from various external input and storage devices such as keyboards, mice, trackballs, disk drives, etc. It is important to note that while the present invention has been (and will continue to be) to include a fully functional computer system, those skilled in the art will appreciate that the various mechanisms of the present invention are capable of being distributed as a program product in a variety of forms, and that the present invention applies equally regardless of the particular type or location of signal to control the apparatus.

I/O interface 135 may be a single bus or multiple computer bus structures. Additionally, I/O interface 135 may communicate via serial or parallel presentation of the data using any type of communication protocol and physical connection, including RS-232, Universal Serial Bus (USB) or any other standard connection means known or developed by those skilled in the art.

Memory controller 130, through use of a processor (not shown) separate from processor 110, is responsible for moving requested information from main memory 120 and/or through I/O interface 135 to processor 110. While for the purposes of explanation, memory controller 130 is shown as a separate entity, those skilled in the art understand that, in practice, portions of the function provided by memory controller 130 may actually reside in the circuitry associated with processor 110, main memory 120, and/or I/O interface 135.

Although computer 105 depicted in FIG. 1 contains only a single main processor 110 and a single system bus 160, it should be understood that the present invention applies equally to computer systems having multiple processors and multiple system buses. Similarly, although the system bus 160 of the preferred embodiment is a typical hardwired, multi-drop bus, any connection means that supports bi-directional communication in a computer-related environment could be used, including wireless communication means.

Main memory 120 suitably contains an operating system 122; a web server application 125; a program interface 127; a participant database 128; and a sponsor database 129. The term “memory” as used herein refers to any storage location in the virtual memory space of computer 105. It should be understood that main memory 120 will not necessarily contain all parts of all mechanisms shown. For example, portions of operating system 122 may be loaded into an instruction cache (not shown) for processor 110 to execute, while other related files may well be stored on magnetic or optical disk storage devices (not shown). In addition, although shown as a single memory structure, it is to be understood that main memory 120 may consist of multiple disparate memory locations.

Operating system 122 includes the software which is used to operate and control computer 105. Operating system 122 is typically executed by processor 110. Operating system 122 may be a single program or, alternatively, a collection of multiple programs which act in concert to perform the functions of any typical operating system, which functions are well known to those skilled in the art.

Web server application 125 is provided to communicate with various web browser applications used by program participants to access the various features and functions of the system.

Program interface 127, program participant database 128, and sponsor 10 database 129 work together to operate the various functions of the application in response to inquiries generated by interested persons and program participants. Program interface 127 is provided to interface with program participants and interested parties via their web browser. Program interface 127 can be used to receive, sort and request information relative to the program participants from program participants and interested parties. For example, when a person registers for the program, the information regarding the registrant will be processed by program interface 127 and then stored in program participant database 128. Additionally, when an interested person wants to access information about a program participant, program interface 127 will format a request, based on the interested person's input, and use the request to parse the information contained in program participant database 128.

Program participant database 128 is any database suitable for use in this application and may be a standard relational database management system (RDBMS) or a custom database designed and optimized for this specific application using any suitable database model. Typically, program participant database 128 will contain information about the participants who have registered with the program. This includes information like name, address, phone number, e-mail address, privacy preferences, etc. Of special note is the demographic information that will be contained in program participant database 128. This information may include age, gender, educational level, buying preferences, etc. This is the information that will allow targeted marketing opportunities to the consortium of corporate sponsors that will participate in the program. If the use of individually identifiable information is objectionable from a privacy standpoint, the individually identifiable information may be amalgamated and used in the aggregate to accomplish similar purposes. In order to protect individual privacy, various safeguards known to those skilled in the art may be employed.

Similar to the use of program participant database 128 to store information relative to program participants, sponsor database 129 is used to store information relative to the various sponsors who are participating in the program. In the most preferred embodiments of the present invention, sponsor database 129 contains the marketing messages and information for presentation to the program participants and the interested parties who make inquiries relative to the program. For example, if a person has received some type of promotional item from a sponsor and desires to sign up for the introduction program, they would navigate to the web site printed on the promotional item and use the information printed on the promotional piece to register. As part of the registration process, program interface 127 would search sponsor database 129 and provide the designated marketing messages, based upon the information provided by the registrant.

Alternatively, sponsor database 129 may also contain information regarding a series of web links that could be used to direct the registrant's web browser to a sponsor's site or to the sponsor's designated promotional materials on the web. Additionally, sponsor database 129 may also contain information about sending respondent-level information to the sponsor, based on the number and types of registrants signing up for the program. This will allow the sponsor to evaluate the effectiveness of the program in meeting the sponsor's objectives. These examples are merely illustrative of the types of information and activity associated with sponsor database 129. Those skilled in the art will recognize many additional possibilities. It should be noted that while program participant database 128 and sponsor database 129 are shown as separate database, they may actually be combined into a single database structure.

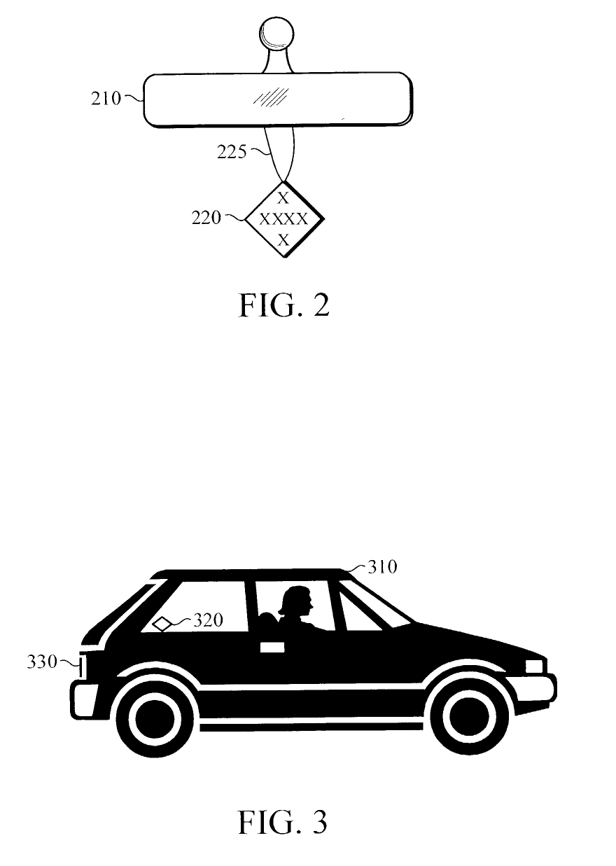

Referring now to FIG. 2, a diagram 200 for a placement location for displaying a program participant identifier according to a preferred exemplary embodiment is shown. As shown in FIG. 2, a program participant identifier 220 can be suspended from a rear-view mirror 210 in a motor vehicle. Program participant identifier 220 is suspended by strap 205. Strap 225 may be manufactured from any material suitable for the purpose and known to those skilled in the art. In the most preferred embodiments of the present invention, program participant identifier 220 is provided by a sponsor and is provided by the sponsor without charge to the program participant.

Program participant identifier 220 is an indicia-bearing object that preferably comprises at least one indicia which is suitable for identifying the program in which the participant participates. It may be manufactured from any variety of materials and may be of any size and shape suitable for the purposes described herein. In the most preferred embodiments of the present invention, program participant identifier 220 is manufactured from an inexpensive plastic or cardboard-like material. Those skilled in the art will recognize many different materials that will be suitable for the fabrication of program participant identifier 220. Program participant identifiers 220 may be distributed by any number of methods. For example, program participant identifiers may be distributed at sporting events, malls, movie theaters, restaurants, bars and grills, etc.

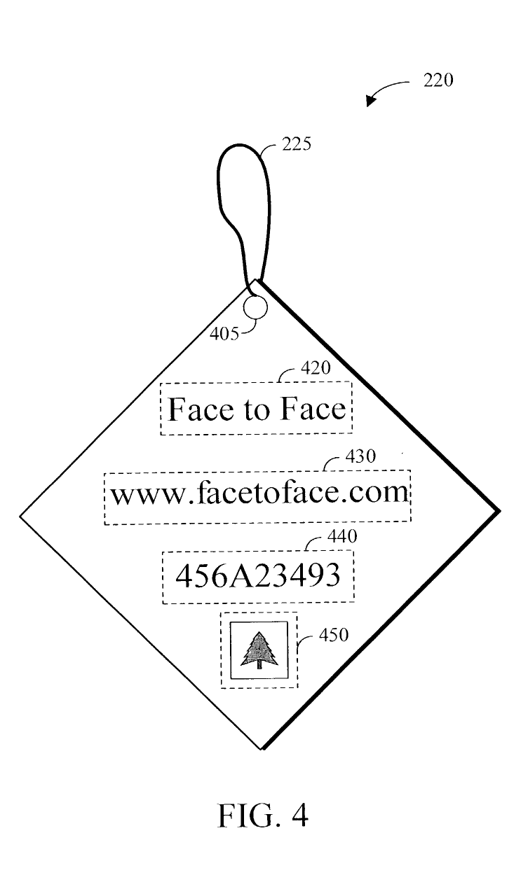

Examples of the types of indicia that may be found on program participant identifier are a program identifier, a program web site identifier, a sponsor logo, and a participant identifier. It should be noted that additional types of indicia may be provided and the specific indicia will be determined by the parameters of each specific program. Further details about the various types of indicia associated with program participant identifier 220 are described below in conjunction with FIG. 4.

Referring now to FIG. 3, a diagram 300 for a placement location on an automobile window useful for displaying a program participant identifier according to a preferred exemplary embodiment is shown. As shown in FIG. 3, a program participant identifier 320 may be placed in a window of vehicle 310. In this case, program participant identifier 320 is an adhesive-backed pre-printed label. Program participant identifier 320 contains various indicia as described in conjunction with FIG. 4 below.

An interested individual may spot an attractive person driving vehicle 310. In that case, the interested individual can make a note of the number on license plate 330. The interested individual can then use the number on license plate 330 to learn more about the driver of vehicle 310 and, if desired, send an e-mail message describing their interest to the driver of vehicle 310. The identity of driver 310 will remain secret unless the driver of vehicle 310 receives the e-mail message and opts to respond. The initial e-mail will be sent to a “dummy” e-mail address and then forwarded to the program participant at their designated e-mail address.

Referring now to FIG. 4, an enlarged view of the program participant identifier 220 of FIG. 2 is shown. Program participant identifier 220 comprises: an aperture 405 for inserting a strap 225 and a series of indicia 420-450. Program participant identifier 220 includes a program identifier indicia 420; a web site indicia 430; a participant-specific identifier indicia 440 and a sponsor logo 450. It should be noted that there is no specific requirement for any or all of the indicia to be included on program participant identifier 220 and most indicia are optional.

Program identifier indicia 420 is provided to identify which specific program a participant is registered with. It is anticipated that various different programs may be launched using the methods of the present invention as disclosed herein. By including program identifier indicia 420, various programs can be created and tailored to a specific group based on demographics or other relevant clustering information. This is especially useful for target marketing and advertising. For example, there may be one program for people of a specific sexual orientation, type of employment, or religious persuasion. Additionally, this information may be communicated by providing different colors for various program identifier indicia 420.

Web site indicia 430 is provided to identify a web site location where an interested party can receive more information regarding a specific program and research specific participants for a given program. By navigating to the specific web site indicated in web site indicia 430, an interested individual may register for the program and inquire about the various participants that have been identified by their participant-specific identifier indicia 440. In the most preferred embodiment of the present invention, the interested individual will be presented with various advertising banners and other forms of marketing presentations when making inquiries at the web site identified by web site indicia 430. Web site indicia 430 is optional and may be included if desired for a specific program.

Participant-specific identifier indicia 440 is provided for those situation where it may be necessary to deploy a program participant identifier 220 in a location other than a vehicle. For example, in certain applications, program participant identifiers 220 may be provided with unique identifying indicia that represents a specific individual program participant. In that case, the program participant may display their program participation identifier 220 in a window of their home or apartment or at their cubicle at the office. In those situations, an interested individual may use the participant-specific identifier indicia 440 and/or a sponsor logo 450 to request information about the program participant.

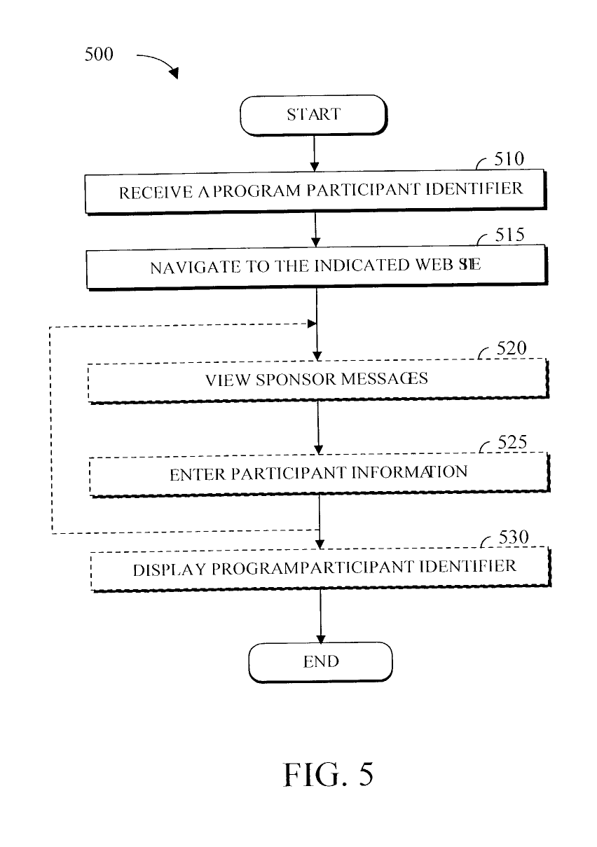

Referring now to FIG. 5, a method 500 for joining a program for meeting potential friends and partners according to a preferred exemplary embodiment of the present invention is shown. As shown in FIG. 5, method 500 begins when a prospective program participant receives a program participant identifier (step 510). There are innumerable ways for a prospective program participant to receive a program participant identifier. For example, the program participant identifier may be handed to prospective program participants at various commercial establishments such as bars, shopping centers, and restaurants.

Additionally, the prospective program participant may receive a program participant identifier at a sporting venue such as a stadium or arena. Other traditional distribution methods such as mass mailings, billing statements, newspaper inserts, and product tie-ins with cold cereal manufacturers and fast food restaurants may also be employed. Anyway that is physically possible for placing a program participant identifier in the hands of a prospective program participant may be employed.

After receiving the program participant identifier from some distribution source, the prospective program participant can utilize any standard web browser application to navigate to the web site address associated with the program participant identifier (step 515). The web site may be a generic program web site or it may be a customized web site, based upon the distribution sponsor's level of involvement in the program.

Once at the web site, the prospective program participant may optionally be exposed to various forms of sponsor messaging (step 520). This could include various type advertising messages and product promotions in the way of banner advertising and/or pop-up and pop-under advertising. Those skilled in the art are aware of the wide variety of advertising messages and technologies used to present advertising messages to consumers via the Internet. Any and all of these various forms of advertising may be employed at the site.

Next, if the prospective program participant wishes to do so, they may register as a program participant. This is accomplished by entering the necessary participant information such as address, phone number, e-mail address, etc. (step 525). After entering their program participant information, the new program participant would display their program participant identifier in the designated manner (step 530).

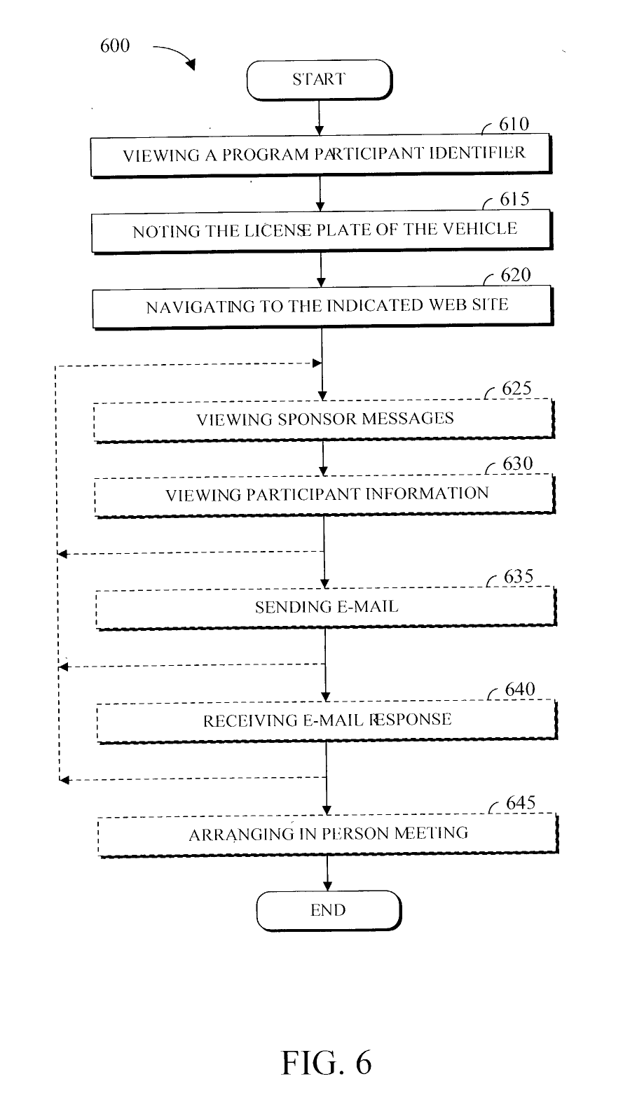

Referring now to FIG. 6, a method 600 for meeting potential friends and partners is shown. As shown in FIG. 6, method 600 begins when an interested party sees a program participant identifier (step 610). As previously explained, this program participant identifier may be strategically attached to or placed in a vehicle or other location so as to draw attention. Typically, an interested person will notice and be attracted to the person associated with the program participant identifier and want to meet them. While this may happen in the normal course of affairs, the program participant identifier, in conjunction with the vehicle license plate or participant identifier indicia will enable the interested party to make contact at a later date or time. By noting the license plate on the vehicle of the program participant (step 615), the interested party can make inquiries at the program web site. The license plate number, or some other piece of information associated with the program participant identifier, can be correlated with the information stored in the program participant database to identify a specific program participant.

With the license plate number or program participant indicia, the interested party can use any standard web browser to navigate to the indicated web site (step 620). At this time, the interested party may be exposed to various forms of sponsor-related advertising and/or promotional materials (step 625). The interested person may also request additional information about a specific program participant by entering the license plate number or program participant indicia. If the sponsoring program and the program participant has authorized viewing of the program participant information by non-program participants, then the requested program participant information will be displayed in the interested person's web browser program (step 630).

If the viewing of the program participant information is not allowed by non-program participants, then the interested person will be offered an opportunity to join the program by completing the steps listed in method 500 of FIG. 5. In that case, a program participant identifier could be printed out on the interested person's printer, mailed to them, or provided in some other fashion. As shown by the various dotted lines in FIG. 6, the interested person may be repeatedly directed back to the sponsors messages (step 625).

If the interested person is further intrigued by viewing the proffered program participant information, then the interested person may send an e-mail to the program participant of their choice (step 635). It should be noted that the e-mail address of the program participants will not generally be viewable nor ascertainable by the inquiring interested person. Rather, the system will use an e-mail forwarding capability to send the e-mail to the program participant.

Next, the program participant will review the information received from the interested person and decide whether or not to respond to the inquiry. If they are also interested in meeting the interested person, they will send a response e-mail to the interested person which will, in time, be received by the interested person (step 640). Once again, the e-mail address of the parties may be kept secret until a later time and multiple anonymous e-mails may be exchanged, once again with or without sponsor messages being attached or included.

Once both parties have decided that they would like to move forward with the relationship, they may choose to reveal additional information, including actual e-mail addresses and then, eventually, arrange an in-person meeting (step 645). In this way, strangers who were introduced by happenstance have the opportunity to become acquainted at their own pace and without the risk/disappointment associated with so many other alternatives.

By employing the methods of the present invention, participants can choose to correspond through the web site with others base strictly on their first impression or look. Next, they can review the personal profile of potential friends and partners and contact them via a secure e-mail facility, which only the recipient of the inquiring email can decide to answer, and only when they choose. Eventually, they may decide to return correspondence and reveal their actual identity and their actual e-mail identity. Participants may be exposed to sponsor messages whenever they give or seek information. The program host may charge a fee to the program participants or, in the most preferred embodiments of the present invention, be paid by the sponsors for the opportunity to present advertising and/or promotional messages to the program participants with payment based on the number of impressions, the demographics of the program participants and many other variables which are well known to those skilled in the art.

It should be noted the consortium of advertisers will each provide their own unique customer base to the program participant database and will synergistically benefit from the opportunity to reach the program participants attracted to the database by other program sponsors. This synergistic activity will be attractive to corporate sponsors in that they will be able to extend their marketing reach within the desired demographic audiences without having directly locating the various members of the desired demographic audience. The off-line meeting aspect of the program, combined with the on-line database will provide access to a large group of potential consumers. Sponsors can also be given the opportunity to become the exclusive sponsor for their specific product or service.

From the foregoing description, it should be appreciated that apparatus and methods for providing introduction for the purpose of meeting is provided and presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only, and are not intended to limit the scope, applicability, or configuration of the invention in any way. Rather, the foregoing detailed description provides those skilled in the art with a convenient road map for implementing a preferred exemplary embodiment of the invention. It being understood that various changes may be made in the function and arrangement of elements described in the exemplary preferred embodiment without departing from the spirit and scope of the invention as set forth in the appended claims.

1. An apparatus comprising:
a program participant database residing in a memory;
a program participant identifier;
at least one piece of information associated with said program participant identifier; and
at least one program participant, said at least one program participant being identified in said program participant database by correlating said at least one piece of information associated with said program participant identifier.

2. The apparatus of claim 1 wherein said at least one piece of information associated with said program participant identifier comprises a license plate number.

3. The apparatus of claim 1 wherein said at least one piece of information associated with said program participant identifier comprises a participant-specific identifier.

4. The apparatus of claim 1 further comprising a web browser residing in said memory.

5. The apparatus of claim 1 further comprising a vehicle displaying said program participant identifier.

6. The apparatus of claim 1 further comprising a sponsor database residing in said memory, said sponsor database containing a plurality of advertising messages.

7. The apparatus of claim 6 wherein said program participant database comprises a plurality of demographic information about said at least one program participant.

8. The apparatus of claim 6 further wherein at least one of said plurality of advertising messages is displayed to said at least one program participant based on said plurality of demographic information.

9. The apparatus of claim 6 further wherein at least one of said plurality of advertising messages is displayed to said at least one program participant by correlating said program participant identifier with said at least one piece of information associated with said program participant identifier.

10. The apparatus of claim 4 wherein at least one advertising message is displayed to said at least one program participant via said web browser.

11. An apparatus for identifying and contacting potential friends and partners comprising:
a vehicle;
an indicia-bearing program participant identifier, said indicia-bearing program participant identifier being displayed in said vehicle, said indicia-bearing program participant identifier bearing at least one indicia;
a license plate affixed to said vehicle;
a memory;
a program participant database residing in said memory, said program participant database describing a plurality of program participants; and
wherein at least one of said plurality of program participants described in said program participant database is identified by correlating said license plate with said program participant database.

12. The apparatus of claim 11 further comprising a sponsor database residing in said memory, said sponsor database containing a plurality of advertising messages.

13. The apparatus of claim 12 further wherein at least one of said plurality of advertising messages is displayed to at least one program participant by correlating said program participant identifier with said license plate.

14. A method comprising the steps of:
viewing a program participant identifier;
navigating to a web site;
entering at least one piece of information associated with said program participant identifier at said web site; and
receiving information about a program participant via said web site.

15. The method of claim 14 wherein said step of entering at least one piece of information associated with said program participant identifier comprises the step of entering a license plate number.

16. The method of claim 14 wherein said step of receiving information about a program participant via said web site comprises the step of receiving an e-mail from said program participant.

17. The method of claim 14 wherein said step of entering at least one piece of information associated with said program participant identifier comprises the step of entering a participant-specific identifier indicia.

18. The method of claim 14 further comprising the step of viewing at least one advertising message.

19. The method of claim 14 further comprising the step of viewing a plurality of advertising messages prior to the step of entering at least one piece of information associated with said program participant identifier at said web site.

20. The method of claim 19 further comprising the step of creating a consortium of advertisers to create said plurality of marketing messages.

21. The method of claim 20 further comprising the step of sharing a plurality of demographic information gathered by said consortium of advertisers.

22. The method of claim 19 further comprising the step of meeting said program participant after the step of receiving information about said program participant via said web site.

23. A program participant identifier comprising:
a web site indicia, said web site indicia describing a location for a web site where said program participant identifier can be correlated to a vehicle license plate number, thereby identifying at least one program participant from a program participant database.

24. The program participant identifier further comprising:
a aperture;
a strap inserted through said aperture;
a program identifier indicia;
a participant-specific identifier indicia; and
a sponsor logo.

25. A method of advertising to a target market audience comprising the steps of:
providing a plurality of program participant identifiers to a plurality of program participants;
entering a plurality of demographic information for each of said plurality of program participants into a program participant database;
tailoring at least one marketing message to said at least one of said plurality of program participants based upon said plurality of demographic information; and
presenting said at least one marketing message to said at least one of said plurality of program participants based upon an action taken by said at least one of said plurality of program participants at a web site.

26. The method of claim 25 further comprising the step of sharing said plurality of demographic information for each of said plurality of program participants with a plurality of sponsors.

27. The method of claim 25 further comprising the steps of:
creating a sponsor database, said sponsor database containing a plurality of marketing messages;
presenting more than at least one of said plurality of marketing messages to at least one of said plurality of said program participants based upon said plurality of demographic information.

28. A method of meeting people comprising the steps of:
receiving a program participant identifier from a sponsor;
navigating to a web site;
entering a plurality of information at said web site, thereby becoming a program participant;
displaying said program participant identifier in a vehicle;
receiving an e-mail inquiry from an interested party who noticed said program participant identifier;
responding to said e-mail inquiry; and
arranging a meeting with said interested party after responding to said e-mail inquiry.

29. The method of claim 28 further comprising the step of presenting at least one marketing message to said program participant.

30. The method of claim 28 further comprising the step of presenting at least one marketing message to said interested party.
